(19) United States
(12) Patent Application Publication
(10) Pub. No.: US 2007/0266385 A1
(43) Pub. Date: Nov. 15, 2007

(54) Performance level setting in a data processing system

(75) Inventors: Krisztian Flautner, Cambridge (GB); Catalin Theodor Marinas, Cambridge (GB)

Correspondence Address: NIXON & VANDERHYE, PC, 901 NORTH GLEBE ROAD, 11TH FLOOR, ARLINGTON, VA, 22203, US

(73) Assignee: ARM Limited, Cambridge (GB)

(21) Appl. No.: 11/431,928

(22) Filed: May 11, 2006

(51) Int. Cl. G06F 9/46

(52) U.S. Cl. 718/102

(57) ABSTRACT

A performance range of a processor in a data processing apparatus is dynamically varied by recalculating at least one performance-range limit in dependence upon a quality of service value for a give processing task. The processor performance level is varied by selecting from a plurality of possible performance levels of a performance range having the performance-range limit.

### BACKGROUND OF THE INVENTION

1. Field of the Invention

This invention relates to data processing systems. More particularly, this invention relates to performance level setting in data processing systems capable of operating at a plurality of different performance levels.

2. Description of the Prior Art

It is known to provide data processing systems capable of operating at a plurality of different performance levels. A data processing system can typically switch between different processor performance levels at run-time. Lower performance levels are selected when running light workloads to save energy (power consumption) whereas higher performance levels are selected for more processing-intensive workloads. Typically, on a processor implemented in complimentary metal-oxide semi conductor (CMOS) technology, lower performance levels imply lower frequency and operating voltage settings.

However, if a workload spends most of its run-time running at close-to-peak performance levels there are likely to be only minor energy savings from switching to lower performance levels as a result of theoretical performance limits in computer scheduling theory (e.g. Amdahl's law). As a result of the difficulty of providing accurate performance prediction, situations are likely to occur whereby task deadlines are missed as a result of mispredictions. This is in turn detrimental to the processing performance of the data processing system and thus the quality of service experienced by the user. Thus there is a requirement to balance the energy savings achieved by reducing the operating frequency and voltage of a processor (according to current processing requirements) against the negative impact resulting from mispredictions that reduce the quality of service.

### SUMMARY OF THE INVENTION

Viewed from one aspect the present invention provides a method of setting a processor performance level of a data processing apparatus, said method comprising:

selectively varying a processor performance level by selecting said processor performance level from a plurality of possible performance levels of a performance range having at least one performance-range limit;

dynamically varying said performance range by recalculating said at least one performance-range limit in dependence upon a quality of service value for a processing task.

The invention recognises that the likelihood of mispredictions of performance levels can be reduced by recalculating at least one performance-range limit in dependence upon a quality of service value for a processing task and by dynamically varying the performance range from which the current processor performance level can be selected. The recalculation of the performance-range limit enables the adaptive increase or reduction of the performance range in which the performance level needs to be predicted. The recalculation of the performance-range limit reduces the likelihood of mispredictions occurring and enables more efficient balancing of the energy savings acquired by reducing the performance level (i.e. processor frequency and voltage) against the negative impact on performance resulting from performance level mispredictions.

In one embodiment, the quality of service value depends on at least one task-specific value characteristic to the processing task. This allows the particular performance requirements of individual processing tasks to be taken into account in limiting the performance range.

In one embodiment, the task-specific value is a task deadline corresponding to a time interval within which the task should have been completed by the data processing apparatus. Task deadlines provide a convenient way of quantitatively assessing the quality of service, since if a given processing task does not meet its task deadline then there are likely to be implications for the quality of service such as delays in the supply of data generated by the given processing task and supplied as input to related processing tasks.

In one embodiment of this type, the task deadline is associated with an interactive task and corresponds to a smallest one of: (i) a task period; and (ii) a value specifying an acceptable response time for a user. This provides a convenient quality of service measure for applications where the response time of the data processing system to interactions with the user has an impact on the perceived quality of service.

In one embodiment, the performance-range limit is calculated in dependence upon a plurality of the task-specific values corresponding to a respective plurality of scheduled processing tasks. This allows the performance range limit to be set according to a plurality of concurrently scheduled processing tasks such that an overall quality of service is ensured, yet also takes account of individual requirements of individual processing tasks, which can vary widely in their quality of service requirements.

In one embodiment, the quality of service depends upon a task tolerance level giving an acceptable level of deviation from the task deadline for the processing task. This provides more flexibility in defining an acceptable performance range and enables a range of tolerances to be specified according to the particular processing task. In one such embodiment the task tolerance level corresponds to a time window containing the task deadline. This provides a convenient way of implementing an acceptable error margin in the tolerance level.

In one embodiment, the tolerance level corresponds to a probability measure associated with the task deadline. In one particular embodiment of this type the probability measure is one of a probability of hitting the task deadline and a probability of missing the task deadline. This enables mathematical models of the probability measure to be formulated and applied to make predictions about likelihoods of meeting and missing task deadlines. Thus the performance-range limit(s) are more accurately determined since run-time parameters of the data processing system are taken into account in estimating the probability measure. The probability measure can be assessed in dependence upon various system parameters such as the current processor frequency and the number of currently active tasks in the data processing system as well as task-specific parameters such as task deadlines and scheduler priority parameters for individual tasks. Other system parameters that can also be used to assess the probability measure are buffer size, and/or how full the buffer is, along with the rate at which the buffer is being drained. A buffer's parameters are particularly relevant as if a task has some real-time deadlines and it has already produced and stored in a buffer enough of the things it needs to (for example decoded music from a music stream), then if something were to go wrong, the data in the buffer can buy some recovery time without impacting on the real-time deadlines.

In one embodiment, the probability measure is calculated in dependence upon a state of an operating system of the data processing apparatus. It will be appreciated that the state of an operating system can be characterised by one or more of a number of different variables that reflect the current processing capability and workload of the data processing system, which in turn affects the quality of service for processing tasks.

In one embodiment, the probability measure is calculated in dependence upon at least one of:

a processor workload for a processing task;

a processor share allocated to the processing task;

a task switching period; and

a total number of scheduled tasks.

The values of these parameters are readily determined by the data processing system and provide an accurate reflection of processing conditions likely to affect the quality of service perceived by the user.

In one embodiment, the probability measure is calculated from a Poisson probability distribution model. A Poisson distribution is well understood mathematically and can be readily applied to model data processing tasks in a data processing system, since it represents a probability distribution that characterises discrete events occurring independently of one another in time.

In one embodiment, the performance limit is recalculated each time the processor performs a task scheduling operation. This ensures that the recalculated performance-range limit is accurate since it should then take account of all of the currently scheduled processing tasks.

It will be appreciated that the performance limit could correspond to any one of a number of different performance criteria of a processor such as a voltage and operating temperature. However, in one embodiment the performance limit corresponds to at least one of an upper limit and a lower limit for an operational frequency of the processor. For processors implemented in CMOS, a lower performance level implies lower frequency and operating voltage settings.

According to a second aspect the present invention provides a computer program product provided on a computer-readable medium, said computer program product comprising:

code for selectively setting a processor performance level by selecting said processor performance level from a plurality of possible performance levels of a performance range having at least one performance-range limit;

code operable to dynamically vary said at least one performance range by recalculating said at least one performance-range limit in dependence upon a quality of service value for a processing task.

According to a third aspect the present invention provides a data processing apparatus comprising:

logic for selectively varying a processor performance level by selecting said processor performance level from a plurality of possible performance levels of a performance range having at least one performance-range limit;

logic for dynamically varying said performance range by recalculating said at least one performance-range limit in dependence upon a quality of service value for a processing task.

The above, and other objects, features and advantages of this invention will be apparent from the following detailed description of illustrative embodiments which is to be read in connection with the accompanying drawings.

### BRIEF DESCRIPTION OF THE DRAWINGS

FIG. 1 schematically illustrates a data processing system capable of dynamically varying a performance range from which a performance level is selected;

FIG. 2 schematically illustrates execution of two different processing tasks in the data processing system of FIG. 1;

FIG. 3 is a graph of the probability of meeting a task deadline against the processor frequency in MHz; and

FIG. 4 is a flow chart that schematically illustrates how the first performance setting policy 156 of FIG. 1 performs dynamic frequency scaling to dynamically vary the performance range.

### DESCRIPTION OF THE PREFERRED EMBODIMENTS

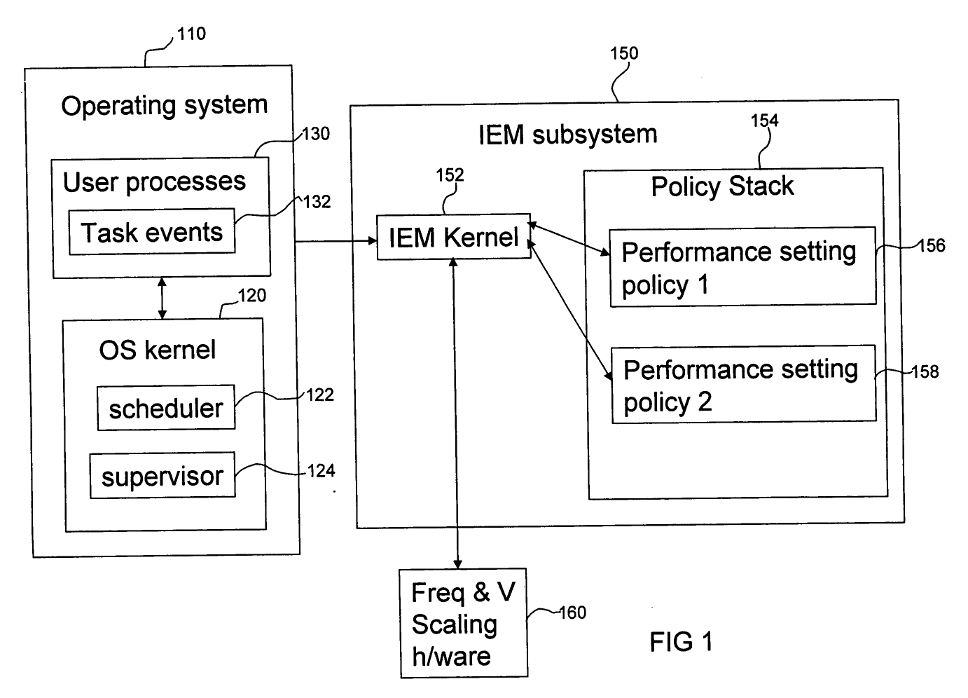

FIG. 1 schematically illustrates a data processing system capable of operating at a plurality of different performance levels and comprising an intelligent energy management subsystem operable to perform selection of a performance level to be used by the data processing system. The data processing system comprises an operating system 110 comprising a user processes layer 130 having a task events module 132. The operating system 110 also comprises an operating system kernel 120 having a scheduler 122 and a supervisor 124. The data processing system comprises an intelligent energy management (IEM) subsystem 150 comprising an IEM kernel 152 and a policy stack having a first performance setting policy module 156 and a second performance setting policy module 158. Frequency and voltage scaling hardware 160 is also provided as part of the data processing system.

The operating system kernel 120 is the core that provides basic services for other parts of the operating system 110. The kernel can be contrasted with the shell (not shown) which is the outermost part of the operating system that interacts with user commands. The code of the kernel is executed with complete access privileges for physical resources, such as memory, on its host system. The services of the operating system kernel 120 are requested by other parts of the system or by an application program through a set of program interfaces known as a system core. The scheduler 122 determines which programs share the kernel's processing time and in what order. The supervisor 124 within the kernel 120 provides access to the processor by each process at the scheduled time.

The user processes layer 130 monitors processing work performed by the data processing system via system call events and processing task events including task switching, task creation and task exit events and also via application-specific data. The task events module 132 represents processing tasks performed as part of the user processes layer 130.

The intelligent energy management subsystem 150 is responsible for calculating and setting processor performance levels. The policy stack 154 comprises a plurality of performance level setting policies 156, 158 each of which uses a different algorithm to calculate a target performance level according to different characteristics according to different nm-time situations. The policy stack 154 co-ordinates the performance setting policies 156, 158 and takes account of different performance level predictions to select an appropriate performance level for a given processing situation at run-time. In effect the results of the two different performance setting policy modules 156, 158 are collated and analysed to determine a global estimate for a target processor performance level. In this particular embodiment the first performance setting policy module 156 is operable to calculate at least one of a maximum processor frequency and a minimum processor frequency in dependence upon a quality of service value for a processing task. The IEM subsystem 150 is operable to dynamically vary the performance range of the processor in dependence upon at least one of these performance limits (i.e. maximum and minimum frequencies). In the embodiment of FIG. 1, the policy stack 154 has two performance setting policies 156, 158, but in alternative embodiments, additional performance setting policies are included in the policy stack 154. In such embodiments where a plurality of performance setting policies are provided, the various policies are organised into a decision hierarchy (or algorithm stack) in which the performance level indicators output by algorithms at upper (more dominant) levels of the hierarchy have the right to override the performance level indicators output by lower (less dominant levels of the hierarchy). Examples of different performance setting policies include: (i) an interactive performance level prediction algorithm which monitors activity to find episodes of execution that directly impact the user experience and ensures that these episodes complete without undue delay; (ii) an application-specific performance algorithm that collates performance information output by application programs that have been adapted to submit (via system calls) information with regard to their specific performance requirements to the IEM subsystem 150; and (iii) a perspectives based algorithm that estimates future utilisation of the processor based on recent utilisation history. Details of the policy stack and the hierarchy of performance request calculating algorithms are described in U.S. patent application Ser. No. 10/687,972, which is incorporated herein by reference. The first performance level setting policy 156, which dynamically calculates at least one performance limit (minimum or maximum frequency) in dependence upon a quality of service value for a processing task, is at the uppermost level of the policy stack 154 hierarchy. Accordingly, it constrains the currently selected processor performance level such that it is within the currently set performance limit(s) (maximum and/or minimum frequencies of range) overriding any requests from other algorithms of the policy stack 154 to set the actual performance level to a value that is less than the minimum acceptable frequency or greater than the maximum acceptable frequency calculated by the first performance setting policy 156. The performance setting policies of the policy stack 154 can be implemented in software, hardware or a combination thereof (e.g. in firmware).

The operating system 110 supplies to the IEM kernel 152, information with regard to operating system events such as task switching and the number of active tasks in the system at a given moment. The IEM kernel 152 in turn supplies the task information and the operating system parameters to each of the performance setting policy modules 156, 158. The performance setting policy modules 156, 158 use the information received from the IEM kernel in order to calculate appropriate processor performance levels in accordance with the respective algorithm. Each of the performance setting policy modules 156, 158 supplies to the IEM kernel a calculated target performance level and the IEM kernel manages appropriate selection of a global target processor performance level. The performance level of the processor is selected from a plurality of different possible performance levels. However, according to the present technique, the range of possible performance levels that can be selected by the IEM kernel is varied dynamically in dependence upon run-time information about the required quality of service for different processing tasks. The frequency and voltage scaling hardware 160 supplies information to the IEM kernel with regard to the currently set operating frequency and voltage whereas the IEM kernel supplies the frequency and voltage scaling hardware with information regarding the required target frequency, which is dependent upon the current processing requirements. When the processor frequency is reduced, the voltage may be scaled down in order to achieve energy savings. For processors implemented in complimentary metal-oxide semiconductor (CMOS) technology, the energy used for a given work load is proportional to voltage squared.

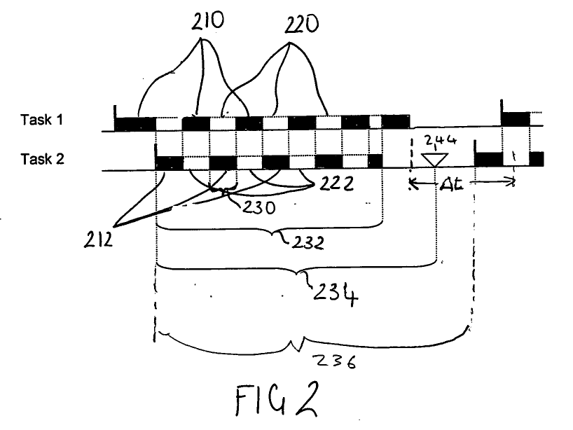

FIG. 2 schematically illustrates execution of two different processing tasks in the data processing system of FIG. 1. The horizontal axis for each of the tasks in FIG. 2 represents time. As shown in FIG. 2, each task is executed as a plurality of discrete scheduling periods 210, which are separated by waiting periods 220. During the waiting periods other currently executing processing tasks are scheduled by the data processing system. In this case where there are only two tasks currently executing in the data processing system it can be seen that the scheduling periods 210 of task 1 coincide with the waiting periods 222 of task 2 and conversely the scheduling periods of task 2 212 coincide with the waiting periods 220 of task 1.

In FIG. 2 a number of task-specific parameters are illustrated. In particular, the time period 230 corresponds to the average task switching interval τ, which in this case corresponds to the typical duration an individual scheduling period. Note that a given scheduling “episode” comprises a plurality of scheduling periods. For example, for a program subroutine, each execution of the subroutine would correspond to a scheduling episode and the processing required to be performed for each scheduling episode will be performed during a number of discrete scheduling periods. Scheduling periods for a given task are punctuated by task switches by the processor. The time interval 232 corresponds to the task completion time for task 2 and represents the time from the beginning of the first scheduling episode of processing task 2 to the end of the last scheduling period of processing task 2 (for a given scheduling episode), whereupon the task is complete. The task period or deadline corresponds to the time interval 234. It can be seen from FIG. 2, that between the end of the task completion time interval 232 and the task 2 deadline (i.e. the end of time period 234) there is “slack time”. The slack time corresponds to the time between when a given task was actually completed and the latest time when it could have been completed yet still meet the task deadline. To save energy while preserving the quality of service in a system, we can only try to reduce the slack time, any further reduction in time and the deadline would be missed.

When the processor is running at full capacity many processing tasks will be completed in advance of their deadlines and in this case, the processor is likely to be idle until the next scheduled task is begun. A larger idle time between the completion of execution of a task and the beginning of the next scheduled event corresponds to a less efficient system, since the processor is running at a higher frequency than necessary to meet performance targets. An example of a task deadline for a task that produces data is the point at which the generated data is required for use by another task. The deadline for an interactive task would be the perception threshold of the user (e.g. 50-100 milliseconds). A convenient quality of service measure for interactive tasks involves defining the task deadline to be the smaller of the task period and a value specifying an acceptable response time for a user. Thus for those processing tasks for which the response time is important in terms of a perceived quality of service, the task deadline can be appropriately set to a value smaller than the task period.

Going at full performance and then idling is less energy-efficient than completing the task more slowly so that the deadline is met more exactly. However, decreasing the CPU frequency below a certain value can lead to a decrease in the “quality of service” for processing applications. One possible way of measuring quality of service for a particular processing task is to monitor the percentage of task deadlines that were met during a number of execution episodes. For periodic applications or tasks having short periods, the task deadline is typically the start of the next execution episode. For a periodic applications or periodic applications with long periods, the task deadline depends on whether the application is interactive (shorter deadline) or performs batch processing (can take longer).

In the case of FIG. 2, the estimated task period (i.e. which is greater than or equal to the task deadline) corresponds to the time interval 236. The idle time of the device corresponds to the time between the end of the completion time 232 and the end of the estimated period T 236. Thus, the slack time is included within the idle time and in the case of the deadline being equal to the estimated period, i.e. 234 and 236 being the same, the idle time and slack time are the same. The time point 244 corresponds to the task deadline by which the task ought to have completed a predetermined amount of processing. However, the first performance setting policy module 156 of FIG. 1 can allow for a tolerance in meeting a given task deadline by defining a tolerance window about the upper limit 244 of the task deadline, such a window is shown in FIG. 2 and indicated by Δt. This provides more flexibility in setting the current processor performance level, particularly where the data processing system allows for a choice between a plurality of discrete processor performance levels rather than allowing for selection from a continuous range.

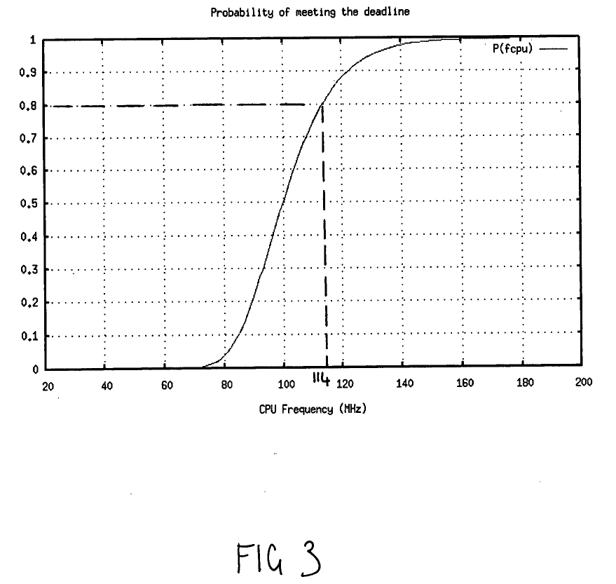

FIG. 3 is a graph of the probability of meeting the task deadline (y-axis) against the processor frequency in MHz (x-axis). In this example the total number of active tasks in executing on the data processing system is two (as for FIG. 2) and the task switching interval is 1 millisecond (ms). The maximum processor frequency in this example is 200 MHz. The task to which the probability curve applies has a task period or deadline of 0.1 seconds (100 ms) and a task switching rate of 500 times per second. It can be seen that, in this particular example, the probability of meeting the task deadline for processor frequencies of less than about 75 MHz is substantially zero and the probability of meeting the deadline increases approximately linearly in the frequency range from 85 MHz to 110 MHz. The probability curve then flattens off between frequencies of 110 MHz and 160 MHz. For frequencies of 160 MHz and above, the task is almost guaranteed to meet its task deadline, since the probability closely approaches one.

Consider the case where the first performance setting policy 156 of the IEM subsystem 150 of FIG. 1 specifies that for the task corresponding to the probability curve of FIG. 3, an acceptable probability of meeting the task deadline corresponds to a probability of 0.8. From the probability curve (FIG. 3) it can be seen that an appropriate minimum processor frequency fₘᵢₙi to achieve this probability of meeting the deadline is 114 MHz. Thus the task-specific lower bound fₘᵢₙi for the CPU frequency is 114 MHz. However, the global lower CPU frequency bound will depend upon a similar determination being performed for each of the concurrently scheduled tasks.

For the task associated with the probability curve of FIG. 3, it can be seen that decreasing the processor frequency below 140 MHz leads to a corresponding decrease in quality of service. In general, the probability of meeting a task deadline progressively diminishes as the processor frequency decreases. The probability for a given task to hit its deadline is clearly a function of the processor frequency. However, this probability is also a function of other system parameters such as: the number of running tasks in the system; the scheduling resolution; task priorities and so on. According to the present technique the frequency range from which the IEM kernel 152 can select the current frequency and voltage of the processor is dynamically varied and restricted in dependence upon a probability function such as that of FIG. 3. However, it will be appreciated that the probabilities of meeting deadlines for a plurality of tasks can be taken into account and not just the probability of meeting the deadline for an individual task.

Task scheduling events scheduled by the task scheduler 122 of FIG. 1 typically have a Poisson distribution in time. This fact is used to determine the probability of hitting or missing a task deadline as a function of:
the processor frequency;
the task's required number of cycles for completion (determined stochastically); the task's deadline;
the task's priority;
the scheduler resolution or task switch interval; and
the number of tasks in the system.

An equation describing the probability function such as the probability function plotted in FIG. 3 is used to derive an inverse probability which can then be used to calculate an appropriate processor frequency for a given probability of missing or meeting the task deadline. We will now consider in detail how the desired frequency limit is calculated and how the probability function of FIG. 3 is derived in this particular embodiment.

The probability of a given processing task hitting (or missing) its task deadline is calculated by the first performance setting policy module in dependence upon both operating system parameters and task-specific parameters.

For a task i scheduled for execution by the data processing system, the following task-specific parameters are relevant in order to calculate the minimum acceptable processor frequency (fₘᵢₙi) that enables the task deadline to be hit for the individual processing task i:
Cᵢ the number of processing cycles needed to be executed on behalf of the task before its deadline;
Tᵢ the task deadline (usually equivalent to the period if the period is not large);
αᵢ scheduler priority parameter; and

Pₕ_{ᵢ} the probability for a task to hit the deadline;

The system (global) parameters are:

f_{CPU} the CPU frequency; and
n the number of active tasks in the system at a given moment.

Assuming that there are n tasks active in at seconds interval and a task switch occurs every τ seconds (τ is of an order of μs or ms), the number of periods a specific task is scheduled in (Nₜ), follows a Poisson distribution with the following probability mass function:

$$P ( {N}_{t} = k ) = {f}_{p} ( k ; λ t ) = \frac{{{ⅇ}^{- λ t} ( λ t )}^{k}}{k !} \qquad ( eqn 1 )$$

where λ is the rate or the expected number of task switches for a specific task in a time unit:

$$\begin{matrix}λ = \frac{ρ}{τ} & ( eqn 2 ) \\ E [ {N}_{t} ] = λ t , var ( {N}_{t} ) = λ t \\ and & ( eqn 3 ) \\ ρ = \frac{{α}_{i}}{{\sum }_{j = 1}^{n} {α}_{j}} & ( eqn 4 )\end{matrix}$$

ρ is the CPU share allocated by the OS scheduler to a specific task. Note that for equal priority tasks, αᵢ=1∀i=1 . . . n and ρ=1/n. α is a task priority parameter. It is an operating system (or scheduler) specific parameter associated to each task. It is not simple to calculate, whereas ρ can be statistically determined.

If M and N are two independent Poisson distributed random variables with λ_{M} and λ_{N} rates, the resulting M+N variable is Poisson distributed as well, with a λ_{M}+λ_{N} rate. This property of the Poisson variables simplifies the case when the number of tasks in the system is not constant in a period T, the resulting variable being Poisson distributed with a

$$\frac{1}{T} {\sum }_{i} {λ}_{i} {t}_{i}$$

rate.

The Poisson distribution, can be approximated by a normal distribution (the bigger λt, the better the approximation):

$$\begin{matrix}{f}_{n} ( k ; μ , σ ) = \frac{1}{σ \sqrt{2 π}} {ⅇ}^{- \frac{{( k - μ )}^{2}}{2 {σ}^{2}}} & ( eqn 5 ) \\ P ( {N}_{t} \leq k ) ≅ {F}_{n} ( k ) & ( eqn 6 )\end{matrix}$$

where μ=λt, σ²=λt and Fₙ(x) is the cumulative normal distribution function:

$${F}_{n} ( x ) = \frac{1}{σ \sqrt{2 π}} {\int }_{- ∞}^{x} {ⅇ}^{- \frac{{( u - μ )}^{2}}{2 {σ}^{2}}} ⅆ u \qquad ( eqn 7 )$$

For small values of λt, the approximation can be improved using a 0.5 continuity correction factor.

A random normal variable X is equivalent to a standard normal variable

$$Z = \frac{X - μ}{σ}$$

having the following cumulative distribution function:

$$Φ ( z ) = \frac{1}{\sqrt{2 π}} {\int }_{- ∞}^{z} {ⅇ}^{- \frac{{u}^{2}}{2}} ⅆ u = \frac{1}{2} [ 1 + erf ( \frac{z}{\sqrt{2}} ) ] \qquad ( eqn 7 )$$

where erf(x) is the error function (monotonically increasing):

$$erf ( x ) = \frac{2}{\sqrt{π}} {\int }_{0}^{x} {ⅇ}^{- {t}^{2}} ⅆ t \qquad ( eqn 8 )$$

with the following limits: erf(0)=0, erf(−∞)=−1, erf(∞)=1. The error function and its inverse can be found pre-calculated in various mathematical tables or can be determined using mathematics software packages such as Matlab®, Mathematica® or Octave®.

The approximated cumulative Poisson distribution function becomes:

$$P ( {N}_{t} \leq k ) ≅ \frac{1}{2} [ 1 + erf ( \frac{k - λ t}{\sqrt{2 λ t}} ) ] \qquad ( eqn 9 )$$

where λ is the expected number of task switches for task i in a given time; Nₜ is the random number representing the scheduling events; k is the number of occurrences of the given event; and P(Nₜ≦k) is the probability that Nₜ is less than or equal to a given k, that is the probability of missing the deadline, i.e. the probability that the number of times a task was scheduled in is less than “k” the number required to complete its job—C cycles and t is time in seconds.

If the probability of a task i missing the deadline is Pₘ then it follows that the probability of hitting the deadline, Pₕ=1−Pₘ.

If C is the number of cycles that should be executed on behalf of a specific task in a period of time T then the number of times (k) that a task i needs to be scheduled so that the deadline is not missed is:

$$k = \frac{C}{τ {f}_{CPU}} \qquad ( eqn 10 )$$

where τ is the task switching period in seconds and f_{CPU} is the current processor frequency.

The probability of missing the deadline becomes:

$$\begin{matrix}{P}_{m} = p ( {N}_{t} \leq k ) ≅ {F}_{n} ( k ) \\ = Φ ( \frac{k - λ T}{\sqrt{λ T}} ) = \frac{1}{2} [ 1 + erf ( \frac{k - λ T}{\sqrt{2 λ T}} ) ]\end{matrix} \qquad ( eqn 11 )$$

In terms of an individual task i, the processor (CPU) workload W for task i is given by:

$$W = \frac{C}{{Tf}_{CPU}} ⇒ k = \frac{WT}{τ} \qquad ( eqn 12 )$$

Since λ=ρ/τ (where λ is the expected number of task switches in a given time; ρ is the CPU share allocated by the OS scheduler 122 to task i; and τ is the task switching period in seconds), the probability Pₘ of missing the task deadline for an individual task is given by:

$${P}_{m} = \frac{1}{2} [ 1 + erf ( \frac{1}{\sqrt{2 ρ τ}} ( W - ρ ) \sqrt{T} ) ] \qquad ( eqn 13 )$$

From the above equation for Pₘ, it can be seen that for tasks having the same priority and the same period, those tasks having a higher associated individual CPU workload have a greater likelihood of missing the task deadline. Furthermore, considering tasks having the same CPU workload, those tasks with longer periods (T) have a higher probability of missing the task deadline.

Since the probability of hitting the deadline (Pₕ=1−Pₘ) is fixed, the above equations lead to a linear equation in k:

$$\frac{k - λ T}{\sqrt{λ T}} {z}_{m} ⇒ k = λ T + {z}_{m} \sqrt{λ T} = ρ \frac{T}{τ} + {z}_{m} \sqrt{ρ \frac{T}{τ}} \qquad ( eqn 14 )$$

where the inverse probability function zₘ for the probability of missing the task deadline is given by:
zₘ=Φ(Pₘ)=\sqrt{2}erf¹(2Pₘ−1) (eqn 15)
From the above equations, the CPU frequency for a given probability of missing the deadline is given by:

$${f}_{CPU} = \frac{C}{τ k} = \frac{C}{ρ T + {z}_{m} \sqrt{ρ T τ}} \qquad ( eqn 16 )$$

where C is the number of cycles that should be executed on behalf of a specific task in a period of time T; k is the number of times that a task i needs to be scheduled so that the deadline is not missed; T is a period of time corresponding to the task deadline (typically equal to the task period); ρ is the CPU share allocated by the OS scheduler 122 to task i; τ is the task switching period in seconds; and zₘ is the inverse probability function for the likelihood of missing the task deadline.

According to the algorithm implemented by the first performance setting policy module 156 of FIG. 1, every task in the system is assigned a maximum acceptable probability of missing the deadline (minimum acceptable probability of hitting the deadline). The actual predetermined acceptable probability that is assigned to each task can be specified by the user and is dependent upon the type of processing task e.g. processing tasks that involve user interaction will have a high minimum acceptable probability of hitting the deadline to ensure that the response time is acceptable to the user whereas processing tasks that are less time-critical will be assigned lower minimum acceptable probabilities. For example, a video player application running on the machine requires good real-time response, while an email application does not.

For simplification, this probability can only take certain predetermined discrete values within a range. Based on these predetermined values, the inverse probability function zₘ (see eqn 15 above) is calculated and stored in memory (e.g. as a table) by the data processing system of FIG. 1.

The first performance setting policy module 156 of FIG. 1 is operable to calculate and track the processor workload W (see eqn 12 above) and period T for each individual processing task i. Based on these values of W and T and the system parameters (e.g. n and f_{CPU}), the module calculates the minimum CPU frequency fₘᵢₙi so that for each of the n scheduled tasks, the probability of missing the deadline Pₘ is smaller than the predetermined acceptable Pₘ associated with the respective task. Thus the lower bound for the system CPU frequency f_{CPU}^{min} corresponds to the largest of the n individual task-specific minimum CPU frequencies fₘᵢₙi.

The constants τ (CPU share allocated by the OS scheduler to task i) and ρ (the task switching period in seconds) are statistically determined by the IEM subsystem at run-time.

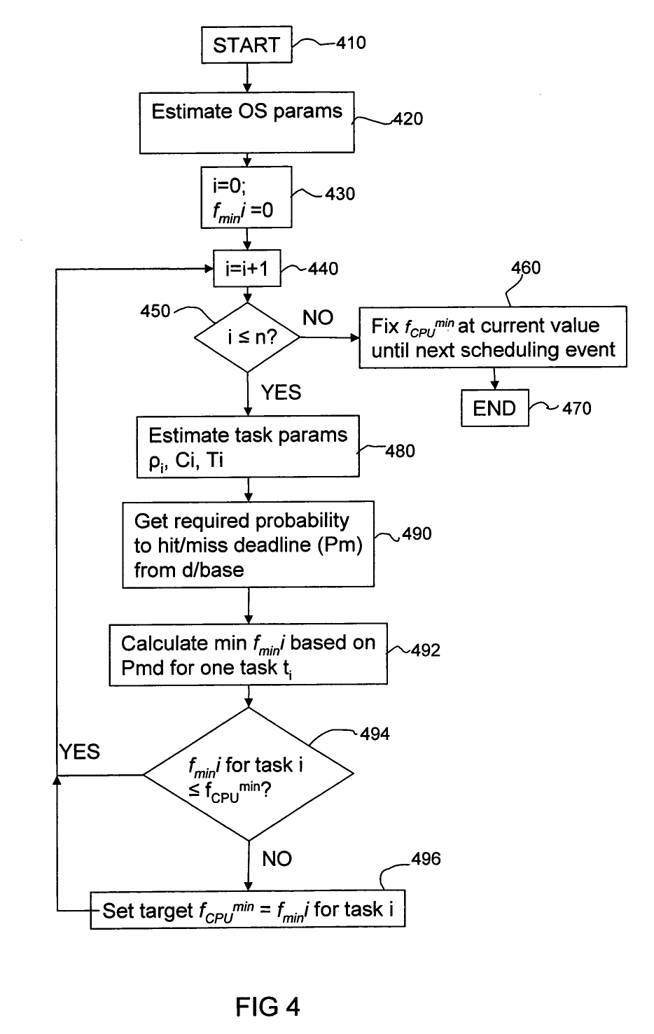

FIG. 4 is a flow chart that schematically illustrates how the first performance setting policy 156 of FIG. 1 performs dynamic frequency scaling to dynamically vary the performance range from which the IEM kernel 152 can select a plurality of possible performance levels. The entire process illustrated by the flow chart is directed towards calculating the minimum acceptable processor frequency f_{CPU}^{min} that enables the probability of meeting task deadlines for each of a plurality of concurrently scheduled processing tasks to be within acceptable bounds. The minimum acceptable frequency f_{CPU}^{min} represents the maximum of the frequencies calculated as being appropriate for each individual task. The value f_{CPU}^{min} represents a lower bound for the target frequency that can be output by the IEM kernel 152 to the frequency and voltage scaling module 160 to set the current processor performance level. The value f_{CPU}^{min} is calculated dynamically and it is recalculated each time the OS kernel 120 of FIG. 1 performs a scheduling operation.

Note that in alternative embodiments, an upper bound f_{CPU}^{max} is calculated instead of or in addition to a lower bound. The upper bound f_{CPU}^{max} is calculated based on task-specific maximum frequencies fₘₐₓi, which are based on a specified upper bound for the required probability of meeting the task deadline associated with that task. The global value f_{CPU}^{max} represents the smallest of the task-specific maximum frequencies fₘₐₓi and should be larger than fcpu^{min} to avoid increasing the probability of missing the deadline for some tasks. The goal of a good voltage-setting system is to arrive at a relatively stable set of predictions and avoid oscillations. The advantage of introducing an upper bound for the maximum frequency is that it helps the system arrive at a relatively stable set of predictions (avoiding or at least reducing oscillations). Oscillations waste energy, it is desirable to arrive at a correct stable prediction as early as possible.

Referring to the flow chart of FIG. 4, the process starts at stage 410 and proceeds directly to stage 420 where various operating system parameters are estimated by the first performance setting policy module 156 based on information supplied to the IEM kernel 152 by the operating system 110. The operating system parameters include the total number of tasks currently scheduled by the data processing system and the current processor frequency f_{CPU}. Next, at stage 430, the task loop-index i is initialised and the global minimum processor frequency f_{CPU}^{min} is set equal to zero.

At stage 440, the task loop-index i is incremented and next at stage 450 it is determined whether or not i is less than or equal to the total number of tasks currently running in the system. If i exceeds the number of tasks in the system, then the process proceeds to stage 460 whereupon f_{CPU}^{min} is fixed at its current value (corresponding to the maximum value for all i Of fₘᵢₙi) until the next task scheduling event and the process ends at stage 470. The policy stack 154 will then be constrained by the first performance setting policy to specifying to the IEM kernel a target processor performance level f_{CPU}^{target} that is greater than or equal to f_{CPU}^{min}.

However, if at stage 450 it is determined that i is less than the total number of tasks currently running in the system then the process proceeds to stage 480 whereupon various task-specific parameters are estimated. In particular, the following task-specific parameters are estimated:
(i) ρᵢ—the CPU share allocated to task i by the operating system scheduler (this value depends on the priority of the task i relative to other currently scheduled tasks);
(ii) τ—the task switching period;
(iii) C—the number of cycles to be executed on behalf of task i before its deadline;
(iv) T—the task period or deadline associated with task i; and
(v) zₘ—the inverse probability function associated with the probability of meeting the task deadline for task i. It is determined (looked up in a table) at or after step 490 (see FIG. 4) and corresponds to the Pₘ value for the given task.

Once the task-specific parameters have been estimated, the process proceeds to stage 490 where the required (i.e. acceptable) probability to meet the deadline for the given task i is read from a database. The required probability will vary according to the type of task involved, for example, interactive applications will have different required probabilities from non-interactive applications. For some tasks, such as time-critical processing operations, the required probability of meeting the task deadline is very close to the maximum probability of one whereas for other tasks it is acceptable to have lower required probabilities since the consequences of missing the task deadline are less severe.

After the required probabilities have been established at stage 490, the process proceeds to stage 492, where the minimum processor frequency for task i (fₘᵢₙi) is calculated based on the corresponding required probability. The process then proceeds to stage 494, where it is determined whether or not the task-specific minimum processor frequency calculated at stage 492 is less than or equal to the current global minimum processor frequency f_{CPU}^{min}.

If the task-specific minimum processor frequency fₘᵢₙi is greater than f_{CPU}^{min}, then the process proceeds to stage 496 where f_{CPU}^{min}, is reset to fₘᵢₙ. The process then returns to stage 440, where i is incremented and fₘᵢₙi is calculated for the next processing task.

On the other hand, if at stage 494 it is determined that fₘᵢₙi is less than or equal to the currently set global minimum frequency f_{CPU}^{min}, then the process returns to stage 440 where the value of i is incremented and the calculation is performed for the next processing task. After stage 496 the process then returns to increment the current task at stage 440.

Although the described example embodiments use the probabilities that processing tasks will meet their task deadlines as a metric for the quality of service of the data processing system, alternative embodiments use different quality of service metrics. For example, in alternative embodiments the quality of service can be assessed by keeping track of the length, task deadline and speed for each execution episode for each processing task to establish the distribution of episode lengths. By speed “required speed” that would have been correct for an on-time execution of an episode is meant. After having executed an episode one can look back and figure out what the correct speed would have been in the first place. is then used to determine the minimum episode length and speed that is likely to save useful amounts of energy. If a performance level prediction lies above the performance-limit derived in this way then the processor speed is set in accordance with the prediction. On the other hand, if the prediction lies below the performance-limit then a higher minimum speed (performance-range limit) is set in order to reduce the likelihood of misprediction.

In the particular embodiment described with reference to the flow chart of FIG. 4, the probability measure is calculated in dependence upon a particular set of system parameters and task-specific parameters. However, it will be appreciated that in different embodiments various alternative parameter sets are used to derive the probability measure. Parameters that reflect the state of the operating system of the data processing apparatus are particularly useful for deriving probability measures. Examples of such parameters include many different things, such as how much page swapping is going on, how much communication between tasks is occurring, how often system calls are being invoked, the average time consumed by the OS kernel, the external interrupts frequency, DMA activities that might block the memory access, cold/hot caches and TLBs.

Although illustrative embodiments of the invention have been described in detail herein with reference to the accompanying drawings, it is to be understood that the invention is not limited to those precise embodiments, and that various changes and modifications can be effected therein by one skilled in the art without departing from the scope and spirit of the invention as defined by the appended claims.

1. A method of setting a processor performance level of a data processing apparatus, said method comprising:
selectively varying a processor performance level by selecting said processor performance level from a plurality of possible performance levels of a performance range having at least one performance-range limit;
dynamically varying said performance range by recalculating said at least one performance-range limit in dependence upon a quality of service value for a processing task.

2. Method according to claim 1, wherein said quality of service value depends on at least one task-specific value characteristic to said processing task.

3. Method according to claim 2, wherein said task-specific value is a task deadline corresponding to a time interval within which said task should have been completed by said data processing apparatus.

4. Method according to claim 3, wherein said task deadline is a task deadline is associated with an interactive task and corresponds to a smallest one of: (i) a task period; and (ii) a value specifying an acceptable response time for a user.

5. Method according to claim 2, wherein said performance-range limit is calculated in dependence upon a plurality of said task-specific values corresponding to a respective plurality of scheduled processing tasks.

6. Method according to claim 3, wherein said quality of service value depends upon a task tolerance level giving an acceptable level of deviation from said task deadline for said task.

7. Method according to claim 6, wherein said task tolerance level corresponds to a time window containing said task deadline.

8. Method according to claim 6, wherein said tolerance level corresponds to a probability measure associated with said task deadline.

9. Method according to claim 8, wherein said probability measure is one of a probability of hitting said task deadline and a probability of missing said task deadline.

10. Method according to claim 8, wherein said probability measure is calculated in dependence upon a state of an operating system of said data processing apparatus.

11. Method according to claim 8, wherein said probability measure is calculated in dependence upon at least one of:
(i) a processor workload (W) for said processing task;
(ii) a processor share (ρ) allocated to said processing task; and
(iii) a task switching period (τ); and
(iv) a total number of scheduled tasks (n).

12. Method according to claim 8, wherein said probability measure is calculated from a Poisson probability distribution model.

13. Method according to claim 1, wherein said performance limit is recalculated each time said processor performs a task scheduling operation.

14. Method according to claim 1, wherein said performance limit corresponds to at least one of an upper limit and a lower limit for an operational frequency of said processor.

15. A computer program product provided on a computer-readable medium, said computer program product comprising:
code for selectively setting a processor performance level by selecting said processor performance level from a plurality of possible performance levels of a performance range having at least one performance-range limit;
code operable to dynamically vary said at least one performance range by recalculating said at least one performance-range limit in dependence upon a quality of service value for a processing task.

16. A data processing apparatus comprising:
logic for selectively varying a processor performance level by selecting said processor performance level from a plurality of possible performance levels of a performance range having at least one performance-range limit;
logic for dynamically varying said performance range by recalculating said at least one performance-range limit in dependence upon a quality of service value for a processing task.

17. Means for processing data comprising:
means for selectively varying a processor performance level by selecting said processor performance level from a plurality of possible performance levels of a performance range having at least one performance-range limit;
means for dynamically varying said performance range by recalculating said at least one performance-range limit in dependence upon a quality of service value for a processing task.
